(19) United States
(12) Patent Application Publication
(10) Pub. No.: US 2026/0369921 A1
(43) Pub. Date: Nov. 19, 2026

(54) RECEPTACLE CONNECTOR

(71) Applicant: KT&G CORPORATION, Daejeon (KR)

(72) Inventor: Hwikyeong AN, Seoul (KR)

(73) Assignee: KT&G CORPORATION, Daejeon (KR)

(21) Appl. No.: 19/103,339

(22) PCT Filed: Aug. 16, 2023
(86) PCT No.: PCT/KR2023/012082

§ 371 Date: Feb. 12, 2025

(30) Foreign Application Priority Data
Aug. 17, 2022 (KR) 10-2022-0102594

(51) Int. Cl. H01R 13/52; H01R 24/60; H01R 107/00

(52) U.S. Cl. CPC H01R 13/5202; H01R 13/5227; H01R 24/60; H01R 2107/00

(57) ABSTRACT

A receptacle connector according to the present disclosure includes: a housing open on one side from a cavity therein; a terminal extending to the open one side from an inside of the housing; a first vent hole formed through the housing; and a membrane to cover the first vent hole and to partition an inside and an outside of the housing.

### TECHNICAL FIELD

The present disclosure relates to a receptacle connector.

### BACKGROUND ART

Connectors, in general, may include a plug connector and a receptacle connector. A receptacle connector, which is mounted on, for example, a printed circuit board (PCB) of an electronic device to be connected to a plug connector, may include a plurality of connection terminals. For instance, connection terminals may be arranged in a manner of satisfying the pin configuration of Universal Serial Bus (USB).

### DISCLOSURE OF INVENTION

### Technical Problem

It is an objective of the present disclosure to provide a receptacle connector that can reduce an air pressure difference between the inside and outside of a device.

It is another objective of the present disclosure to provide a receptacle connector with improved waterproof performance.

It is yet another objective of the present disclosure to provide a receptacle connector that can improve the durability of a device.

The objectives of the present disclosure are not limited to the objectives described above, and other objectives not stated herein will be clearly understood by those skilled in the art from the following description.

### Solution to Problem

According to one aspect of the subject matter described in this application, a receptacle connector includes: a housing open on one side from a cavity therein; a terminal extending to the open one side from an inside of the housing; a first vent hole formed through the housing; and a membrane to cover the first vent hole and to partition an inside and an outside of the housing.

### Advantageous Effects of Invention

According to at least one of the embodiments of the present disclosure, an air pressure difference between the inside and outside of a device may be reduced.

According to at least one of the embodiments of the present disclosure, the waterproof performance of a device may be improved.

According to at least one of the embodiments of the present disclosure, the durability of a device may be improved.

Further scope of applicability of the present disclosure will become apparent from the following detailed description. However, it should be understood that the detailed description and specific embodiments such as preferred embodiments of the present disclosure are given by way of example only, since various changes and modifications within the idea and scope of the present disclosure may be clearly understood by those skilled in the art.

### BRIEF DESCRIPTION OF DRAWINGS

FIGS. 1 to 21 illustrate examples of a receptacle connector according to embodiments of the present disclosure.

### MODE FOR THE INVENTION

Description will now be given in detail according to exemplary embodiments disclosed herein, with reference to the accompanying drawings. For the sake of brief description with reference to the drawings, the same or equivalent components are provided with the same or similar reference numerals, and description thereof will not be repeated.

In the following description, a suffix such as “module” and “unit” may be used to refer to elements or components. Use of such a suffix herein is merely intended to facilitate description of the specification, and the suffix itself is not intended to give any special meaning or function.

In the present disclosure, that which is well known to one of ordinary skill in the relevant art has generally been omitted for the sake of brevity. The accompanying drawings are used to help easily understand the technical idea of the present disclosure and it should be understood that the idea of the present disclosure is not limited by the accompanying drawings. The idea of the present disclosure should be construed to extend to any alterations, equivalents, and substitutes besides the accompanying drawings.

It will be understood that although the terms “first”, “second”, etc. may be used herein to describe various elements, these elements should not be limited by these terms. These terms are only used to distinguish one element from another.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, a singular representation is intended to include a plural representation unless the context clearly indicates otherwise.

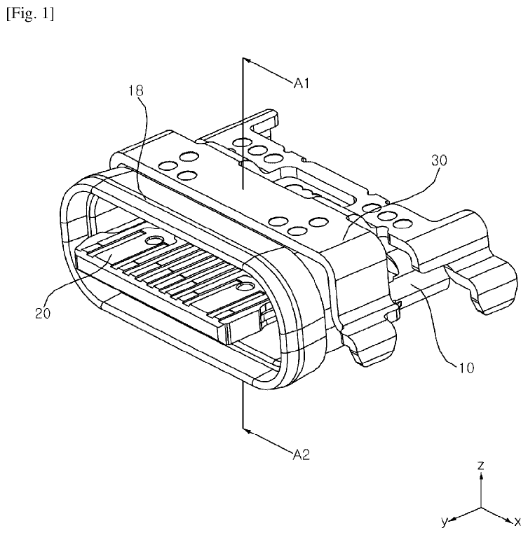

Referring to FIG. 1, a receptacle connector 2 may be mounted on a substrate or the like.

The receptacle connector 2 may include a connector unit 20. The connector unit 20 may extend to one side. The connector unit 20 may have a plate shape. For example, the connector unit 20 may have a plate shape that has a thin thickness in a z direction and is elongated in x and y directions.

The connector unit 20 may be coupled to a plug connector (not shown). The plug connector may be electrically connected to the receptacle connector 2.

The receptacle connector 2 may include a housing 10. The housing 10 may surround the connector unit 20. The housing 10 may have a cavity 121 formed therein. The housing 10 may be open on at least one side from the cavity 121 therein. The plug connector may be inserted into an opening 122 of the housing 10. The inserted plug connector may be coupled to the connector unit 20.

The cavity 121 of the housing 10 may correspond to the plug connector. The cavity 121 may be surrounded by an inner wall of the housing 10. The inner wall of the housing 10 may come into contact with the plug connector. The plug connector may be fixed by the inner wall of the housing 10. For example, the cavity 121 of the housing 10 may correspond to the plug connector, and the plug connector that is disposed in the cavity 121 of the housing 10 may come into contact with the inner wall of the housing 10.

The connector unit 20 may be fixed to one side of the inner wall of the housing 10. The connector unit 20 may extend to one side from the cavity 121 of the housing 10. The connector unit 20 may extend from the cavity 121 of the housing 10 toward the opening 122. The connector unit 20 may protrude from an inside of the housing 10 toward the opening 122. An end of the connector unit 20 may be located outward relative to the opening 122 of the housing 10. For example, the connector unit 20 may be elongated in the y direction, and one end of the connector unit 20 in the y direction may be located at a position corresponding to the opening 122 of the housing 10.

The receptacle connector 2 may include a housing sealer 18 to cover an edge of the opening 122 of the housing 10. The housing sealer 18 may be disposed between a device (not shown) and the housing 10. The housing sealer 18 may fill a gap between the device and the receptacle connector 2. The housing sealer 18 may prevent foreign matter from entering an inside of the device. The housing sealer 18 may correspond to the edge of the opening 122 of the housing 10. The housing sealer 18 may come into contact with an outer wall of the housing 10. The housing sealer 18 may extend along a periphery or perimeter of the opening 122. For example, the housing sealer 18 may have a rectangular loop shape so as to correspond to the edge of the opening 122 of a rectangular shape.

The receptacle connector 2 may include a shell 30. The shell 30 may fix or secure the receptacle connector 2 to the device. The shell 30 may connect the receptacle connector 2 and the device.

The shell 30 may be disposed on one side of the housing 10. The shell 30 may come into contact with the outer wall of the housing 10. The shell 30 may be fixed to the housing 10. The shell 30 and the housing 10 may be coupled by brazing. The shell 30 may extend in a longitudinal direction of the connector unit 20. For example, the shell 30 may extend in the x and y directions.

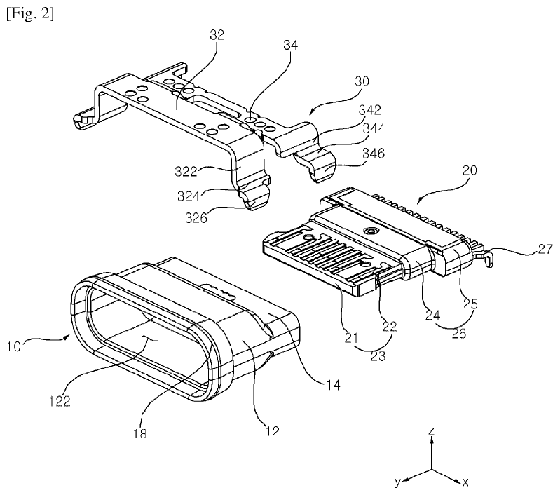

Referring to FIG. 2, a terminal 23 may include a pin 22. The pin 22 may extend long to one side. The pin 22 may transmit and receive an electrical signal through contact with the plug connector. The pin 22 may be provided in plurality. The plurality of pins 22 may be arranged side by side toward one side.

The plurality of pins 22 may be disposed on a plate 21. The plate 21 may extend long to one side. A width of the plate 21 may extend in a longitudinal direction of the pin 22. For example, the width of the plate 21 may extend in the y direction.

The width of the plate 21 may correspond to a length of the pin 22. The pin 22 may be elongated in a widthwise direction of the plate 21.

The plurality of pins 22 may be disposed on one surface and another surface of the plate 21. The another surface may be opposite to the one surface. The plurality of pins 22 may be disposed on an upper surface of the plate 21 in the z direction, for example.

The connector unit 20 may include a terminal body 26. The terminal body 26 may extend in a lengthwise or longitudinal direction of the plate 21. The terminal body 26 may be elongated in a direction in which the plurality of pins 22 are arranged. The terminal body 26 may be elongated in a direction perpendicular to a longitudinal direction of the terminal 23. For example, the terminal 23 may be elongated in the y direction, and the terminal body 26 may be elongated in the x direction.

The terminal 23 may extend from the terminal body 26. The terminal 23 may be fixed to the terminal body 26. For example, the terminal 23 may extend from the terminal body 26 in the y direction.

An electrical signal received through the terminal 23 may move to a connection pin 27 through the terminal body 26.

The terminal body 26 may include a terminal fixing portion 24. The terminal fixing portion 24 may be connected to the terminal 23. The terminal 23 may be fixed to the terminal fixing portion 24. The terminal fixing portion 24 may be disposed between a housing fixing portion 25 and the terminal 23. The terminal fixing portion 24 may connect the terminal 23 and the housing fixing portion 25.

The terminal body 26 may include the housing fixing portion 25. The housing fixing portion 25 may be inserted into an insertion portion of the housing 10. The housing fixing portion 25 may be coupled to the housing 10. The housing fixing portion 25 may be coupled to another side of the housing 10 opposite to the open one side of the housing 10.

The connector unit 20 may include the connection pin 27. The connection pin 27 may be connected to the terminal body 26. The connection pin 27 may define one end of the connector unit 20. For example, the terminal 23 may be disposed on one side of the connector unit 20, and the connection pin 27 may be disposed on another side of the connector unit 20.

The housing 10 may include a first housing 12. The cavity 121 may be formed in the first housing 12. The opening 122 extending from the cavity 121 may be formed in the first housing 12.

The housing sealer 18 may be disposed on the first housing 12. The housing sealer 18 may be disposed on one end of the first housing 12. The housing sealer 18 may surround an outer wall of the first housing 12 that corresponds to the opening 122. For example, the housing sealer 18 may extend along a periphery of one end of the first housing 12 that corresponds to the opening 122.

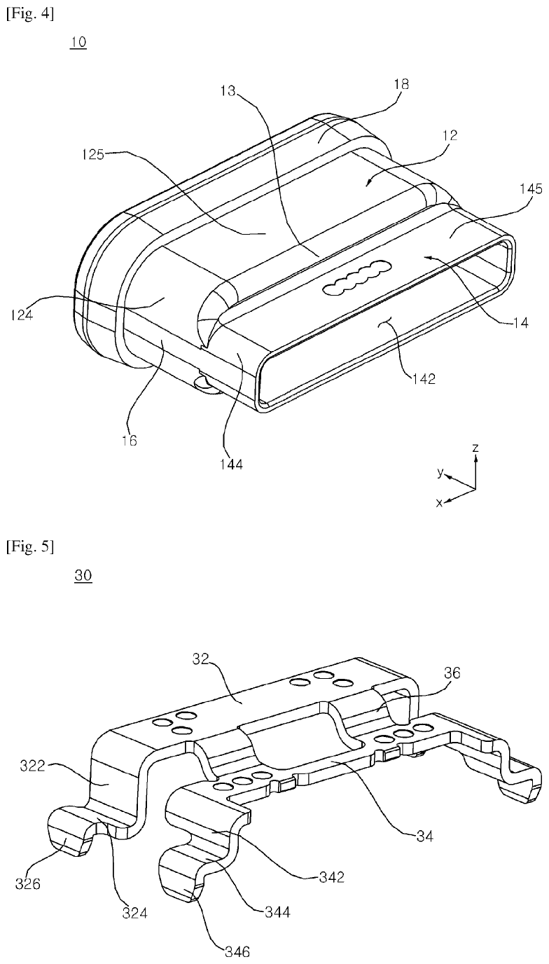

The housing 10 may include a second housing 14. The second housing 14 may be connected to the first housing 12. The connector unit 20 may be coupled to the second housing 14. The connector unit 20 may be inserted into the second housing 14. The second housing 14 may have an insertion portion 142 (see FIG. 4) to allow the connector unit 20 to be inserted therein. The housing fixing portion 25 may be fixed to the insertion portion 142 of the second housing 14. The housing fixing portion 25 may correspond to the insertion portion 142 of the second housing 14. For example, the housing fixing portion 25 of the connector unit 20 may be inserted into and fixed to the second housing 14 of the housing 10.

The second housing 14 may be formed smaller than the first housing 12. For example, a length (x direction) of the second housing 14 may correspond to a length of the first housing 12, and a width (z direction) of the second housing 14 may be less than a width of the first housing 12.

The shell 30 may include a first shell 32. The first shell 32 may be fixed inside the device. The first shell 32 may be disposed on the first housing 12. The first shell 32 may extend in a direction perpendicular to the longitudinal direction of the pin 22. For example, the first shell 32 may be elongated in a direction (x direction) perpendicular to the longitudinal direction (y direction) of the pin 22. The first shell 32 may come into contact with the housing 10, so that the housing 10 may be fixed at a predetermined position to prevent separation of the housing 10.

An end in a longitudinal direction of the first shell 32 may be bent. The first shell 32 may include a first side shell 322. The first side shell 322 may be disposed on the first housing 12. The first side shell 322 may be bent and extend from the first shell 30. The first side shell 322 may be bent to be parallel with the longitudinal direction of the first shell 32 to thereby define a first flange 324. The first flange 324 may be bent to be parallel with the first side shell 322 to thereby define a first rib 326. The first side shell 322 may fix the housing 10 at a predetermined position so that the housing 10 is not separated from the inside of the device.

The shell 30 may include a second shell 34. The second shell 34 may be elongated in the longitudinal direction of the first shell 32. The second shell 34 may be connected with the first shell 32 in a spaced manner. The second shell 34 and the first shell 32 may be connected by a bridge 36.

The second shell 34 may come into contact with the second housing 14. An end in a longitudinal direction of the second shell 34 may be bent to define a second side shell 342. The second side shell 342 may be parallel with the first side shell 322. The second side shells 342 may respectively come into contact with one surface and another surface of the second housing 14. The second side shell 342 may be bent in the longitudinal direction of the second shell 34 to thereby define a second flange 344. The second flange 344 may be bent to be parallel with the second side shell 342 to thereby define a second rib 346. The second rib 346 may come into contact with the inside of the device. The second rib 346 may be brazed to the inside of the device.

The first shell 32 and the second shell 34 may be spaced apart from each other to correspond to the first housing 12 and the second housing 14, respectively. For example, the first shell 32 may be positioned upward in the z direction and forward in the y direction relative to the second shell 34, so that the first shell 32 is in contact with the first housing 12, and the second shell 34 is in contact with the second housing 14.

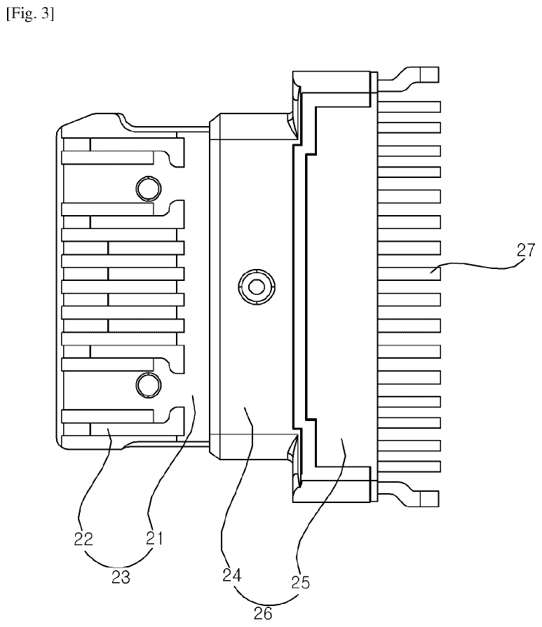

Referring to FIG. 3, the connector unit 20 may include the terminal 23. The terminal 23 may include the pin 22. The pin 22 may extend long to one side. The pin 22 may come into contact with the plug connector. For example, the pin 22 may come into contact with the plug connector to achieve an electrical connection therebetween.

The pin 22 may be provided in plurality. The plurality of pins 22 may be arranged in parallel along the longitudinal direction. The plurality of pins 22 may be disposed in parallel on the plate 21. The plurality of pins 22 may be disposed on one surface and another surface of the plate 21.

The plate 21 may extend in the longitudinal direction of the pin 22 to allow the plurality of pins 22 to be disposed thereon. For example, the plate 21 may be a rectangle with a longer side extending in a direction in which the plurality of pins 22 are arranged and a shorter side extending in the longitudinal direction of the pin 22.

The connector unit 20 may include the terminal body 26. The terminal body 26 may be elongated in a direction in which the plurality of pins 22 are arranged. The terminal body 26 may be connected to the terminal 23. The terminal 23 may extend to one side from the terminal body 26. The terminal body 26 may be connected at one side thereof to the terminal 23, and may be connected at another side thereof to the connection pin 27.

The connector unit 20 may include the connection pin 27. The connection pin 27 may be connected to a substrate or a battery (not shown). The connection pin 27 may be provided in plurality. The plurality of connection pins 27 may be connected in parallel to the terminal body 26. The connection pin 27 may extend in the longitudinal direction of the pin 22. For example, the plurality of connection pins 27 may be elongated in the longitudinal direction of the pin 22, and may be connected in parallel to one side of the terminal body 26 opposite to another side of the terminal body 26 on which the terminal 23 is disposed.

Referring to FIG. 4, the housing 10 may include the insertion portion 142 into which the connector unit 20 is inserted. The insertion portion 142 may be formed inside the second housing 14. The terminal body 26 of the connector unit 20 may be inserted into the insertion portion 142. For example, the terminal 23 may be inserted into the insertion portion 142 first, and then the housing fixing portion 25 may be inserted into the insertion portion 142 while being in contact with the inner wall of the second housing 14.

The housing 10 may include the first housing 12 and the second housing 14. The second housing 14 may correspond to the housing fixing portion 25. The terminal 23 may be disposed in the first housing 12. The first housing 12 and the second housing 14 may define a side portion 16. The side portion 16 may define a side surface of the first housing 12 and a side surface of the second housing 14.

The first housing 12 may include a first flat portion 125. The first flat portion 125 may define one surface and another surface of the first housing 12. The side portion 16 may be bent from the first flat portion 125. A first bending portion 124 may be formed between the first flat portion 125 and the side portion 16. The first bending portion 124 may be gently bent. The first bending portion 124 may be rounded.

The second housing 14 may include a second flat portion 145. The second flat portion 145 may define one surface and another surface of the second housing 14. For example, the second flat portion 145 may define upper and lower surfaces of the second housing 14 in the z direction.

The second flat portion 145 may be provided on each of one side and another side of the insertion portion 142. For example, the second flat portion 145 may be provided on each of upper and lower sides of the insertion portion 142 in the z direction. The side portion 16 may be bent from the second flat portion 145. A second bending portion 144 may be formed between the side portion 16 and the second flat portion 145. The second bending portion 144 may be rounded.

The first flat portion 125 and the second flat portion 145 may be connected by a connection wall 13. The connection wall 13 may be disposed between the first bending portion 124 and the second bending portion 144. The connection wall 13 may be elongated between the first flat portion 125 and the second flat portion 145. The plug connector that is inserted into the receptacle connector 2 may come into contact with the connection wall 13. The connection wall 13 may prevent the plug connector from being inserted more than a predetermined depth into the receptacle connector 2.

Referring to FIG. 5, the shell 30 may include the first shell 32 and the second shell 34. The first shell 32 and the second shell 34 may be connected by the bridge 36. The bridge 36 may be inclined. For example, the second shell 34 may be positioned downward in the z direction relative to the first shell 32, and the bridge 36 may connect the first shell 32 and the second shell 34.

The bridge 36 may be provided in plurality. The plurality of bridges 36 may be disposed between the first shell 32 and the second shell 34. For example, two bridges 36 may be disposed between the first shell 32 and the second shell 34.

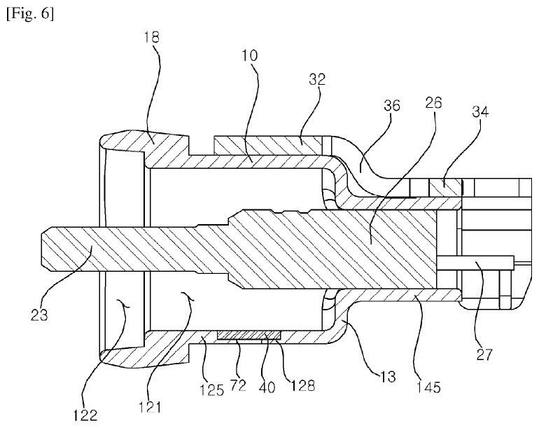

FIG. 6 is a cross-sectional view taken along line A1-A2 of FIG. 1.

Referring to FIG. 6, the housing 10 may include a first vent hole 72. The first vent hole 72 may be formed through the housing 10. The first vent hole 72 may be positioned between the inside and outside of the housing 10. The inside and outside of the housing 10 may communicate with each other via the first vent hole 72. Air inside the housing 10 may flow out of the housing 10 through the first vent hole 72. Air outside the housing 10 may flow in the housing 10 through the first vent hole 72.

Accordingly, an air pressure difference between the inside and outside of the device may be reduced.

The first vent hole 72 may be disposed in the first housing 12 of the housing 10. The first vent hole 72 may be disposed in the first flat portion 125 of the first housing 12. A membrane 40 may be disposed on the inner wall of the housing 10. The membrane 40 may protrude from the inner wall of the housing 10.

The housing 10 may include a recess 128. The recess 128 may be recessed from the inner wall of housing 10. The recess 128 may correspond to a position of the first vent hole 72. The recess 128 may be formed around the first vent hole 72. A size of the recess 128 may correspond to a size of the membrane 40 to be described later. The first vent hole 72 may be disposed in the recess 128.

The membrane 40 may be disposed in the recess 128. The membrane 40 may be disposed in the recess 128, and may define one surface of the housing 10. A depth of the recess 128 may correspond to a thickness of the membrane 40. For example, the recess 128 may be formed in an inner wall of the first flat portion 125, and the membrane 40 may be disposed in the recess 128 to thereby define the inner wall of the first flat portion 125.

The membrane 40 may face the first vent hole 72.

The membrane 40 may be a film. The membrane 40 may be a functional membrane. The membrane 40 may selectively allow fluids to pass therethrough.

The membrane 40 may be gas permeable. The membrane 40 may be bidirectionally gas-permeable. For example, gas inside the housing 10 may pass through the membrane 40 to flow out of the housing 10, and gas outside the housing 10 may pass through the membrane 40 to flow in the housing 10. For example, gas inside the device may pass through the first vent hole 72 and the membrane 40 to flow out of the device, and gas outside the device may pass through the first vent hole 72 and the membrane 40 to flow in the device.

Accordingly, an air pressure difference between the inside and outside of the device may be reduced.

The membrane 40 may be liquid impermeable in at least one direction. For example, liquid inside the housing 10 may not pass through the membrane 40, and liquid outside the housing 10 may pass through the membrane 40 to flow in the housing 10. For example, liquid inside the device may pass through the membrane 40 to flow out of the device, and liquid outside the device may not pass through the membrane 40.

Thus, the waterproof performance of the device may be improved.

The terminal body 26 may be inserted into the second shell 34. The second flat portion 145 of the second shell 34 may come into contact with the terminal body 26. A gap may not be formed between the second flat portion 145 and the terminal body 26. Foreign matter may not pass between the second flat portion 145 and the terminal body 26. For example, fluid inside the housing 10 may not pass between the terminal body 26 and the second shell 34.

A portion of the terminal body 26 may be disposed in the cavity 121 of the housing 10.

The terminal 23 may be disposed in the cavity 121 of the housing 10. The terminal 23 may extend from the cavity 121 of the housing 10 toward the opening 122. A portion of the terminal 23 may protrude through the opening 122. A portion of the terminal 23 may be disposed outside the housing 10.

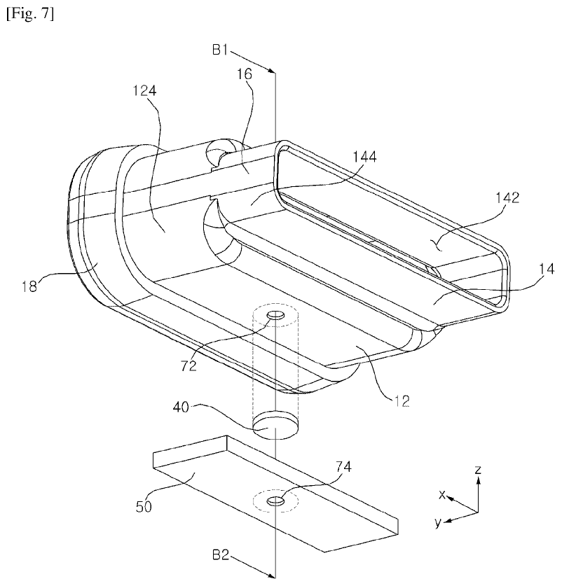

Referring to FIG. 7, in this embodiment, the membrane 40 may be disposed outside the housing 10. The membrane 40 may come into contact with the outer wall of the housing 10. The membrane 40 may be disposed outside the housing 10 to correspond to the first vent hole 72. For example, the first vent hole 72 may be formed in a first flat portion 125 on a lower side of the first housing 12 of the housing 10 in the z direction, and the membrane 40 may come into contact with a lower side in the z direction of the lower first flat portion 125 so as to correspond to the first bent hole 72.

The receptacle connector 2 may further include a support 50 disposed on one side of the membrane 40. The support 50 may come into contact with one side of the membrane 40 opposite to another side of the membrane 40 in contact with the housing 10. The membrane 40 may be disposed between the support 50 and the housing 10.

The support 50 may support the membrane 40 so that the membrane 40 is not separated from the housing 10. The support 50 may come into contact with the first flat portion 125 in which the first vent hole 72 is formed.

The support 50 may include a second vent hole 74. The second vent hole 74 may correspond to the first vent hole 72. A size of the second vent hole 74 may correspond to a size of the first vent hole 72. The support 50 may be disposed side by side with the second vent hole 74 and the first vent hole 72.

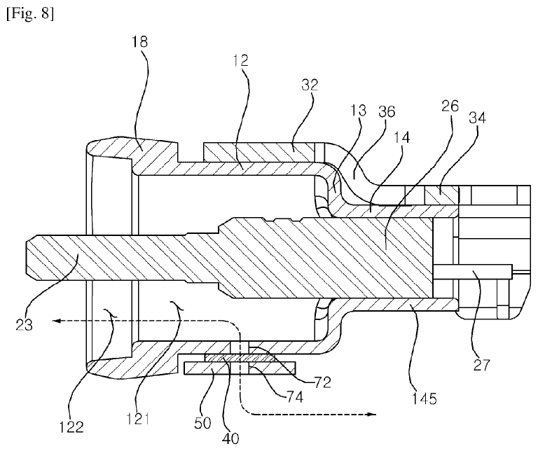

FIG. 8 is a cross-sectional view taken along line B1-B2 of FIG. 7.

Referring to FIG. 8, the first vent hole 72 and the second vent hole 74 may be arranged aligned with each other. The membrane 40 may be disposed between the first vent hole 72 and the second vent hole 74. Air inside and outside the housing 10 may flow through the first vent hole 72 and the second vent hole 74. For example, gas introduced into the first vent hole 72 may pass through the membrane 40 and then be discharged into the second vent hole 74. For example, gas introduced into the second vent hole 74 may pass through the membrane 40 and then be discharged into the first vent hole 72. For example, gas inside the device may be introduced into the second vent hole 74, pass through the membrane 40, and then be discharged through the first vent hole 72. For example, gas outside the device may be introduced into the first vent hole 72, pass through the membrane 40, and then be discharged through the second vent hole 74.

Accordingly, an air pressure difference between the inside and outside of the device may be reduced, and the durability of the device may be improved.

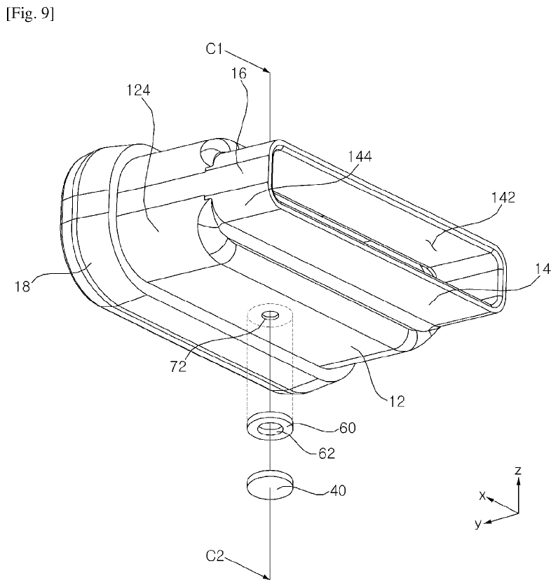

Referring to FIG. 9, in this embodiment, the receptacle connector 2 may further include a gasket 60 disposed between the membrane 40 and the housing 10. The gasket 60 may be disposed to correspond to the first vent hole 72. The gasket 60 may be disposed around the first vent hole 72. The gasket 60 may extend along an edge of the first vent hole 72.

The gasket 60 may be provided to correspond to the membrane 40. For example, the membrane 40 may be a circular thin film, and the gasket 60 may be a circular thin member corresponding to the membrane 40.

The gasket 60 may have a gasket hole 62 in communication with the first vent hole 72. The gasket hole 62 may correspond to the first vent hole 72. A size of the gasket hole 62 may be greater than a size of the first vent hole 72. The gasket hole 62 may be disposed around the first vent hole 72. The gasket hole 62 may be spaced apart from the first vent hole 72 to extend along a circumference of the first vent hole 72. For example, the first vent hole 72 may be a circular hole formed through the housing 10, and the gasket hole 62 may be a circular hole formed through a central portion of the gasket 60 of a circular shape.

The gasket 60 provided therein with the gasket hole 62 may have a loop shape.

The gasket 60 may fix or secure the membrane 40 to the housing 10. The gasket 60 may be bonded to the housing 10. The gasket 60 may be bonded to the membrane 40. The gasket 60 may be an adhesive member. For example, the gasket 60 may be a double-sided adhesive member.

The gasket 60 may be waterproof. The gasket 60 may be liquid impermeable. The gasket 60 may be gas impermeable. For example, the gasket 60 may seal a gap between the housing 10 and the membrane 40.

Accordingly, the waterproof performance of the receptacle connector may be improved.

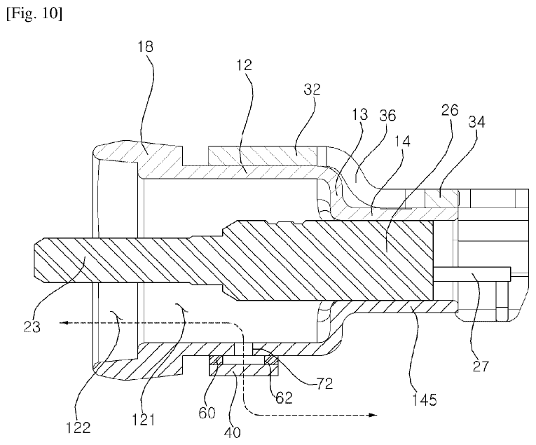

FIG. 10 is a cross-sectional view taken along line C1-C2 of FIG. 9.

Referring to FIG. 10, gas may pass through the first vent hole 72. Gas may pass through the gasket hole 62. The membrane 40 may be gas permeable. For example, gas inside the housing 10 may pass through the first vent hole 72 and the gasket hole 62, and then pass through the membrane 40 to flow out of the housing 10. For example, gas outside the housing 10 may pass through the membrane 40, pass through the gasket hole 62, and then flow in the housing 10 through the first vent hole 72. For example, gas outside the device may pass through the first vent hole 72 and the gasket 60 hole in sequence, and then pass through the membrane 40 to flow in the device. For example, gas inside the device may pass through the membrane 40, pass through the gasket hole 62, and then flow out of the device through the first vent hole 72.

The membrane 40 may be liquid impermeable in at least one direction. For example, liquid outside the device may pass through the first vent hole 72 and the gasket hole 62, but may not pass through the membrane 40. For example, liquid inside the device may pass through the membrane 40, pass through the gasket hole 62, and then flow out of the device through the first vent hole 72.

Accordingly, liquid inside the device may be discharged to the outside. Also, liquid outside the device may be blocked from entering the inside of the device. In addition, the waterproof performance of the receptacle connector may be improved. Further, an air pressure difference between the inside and outside of the device may be improved.

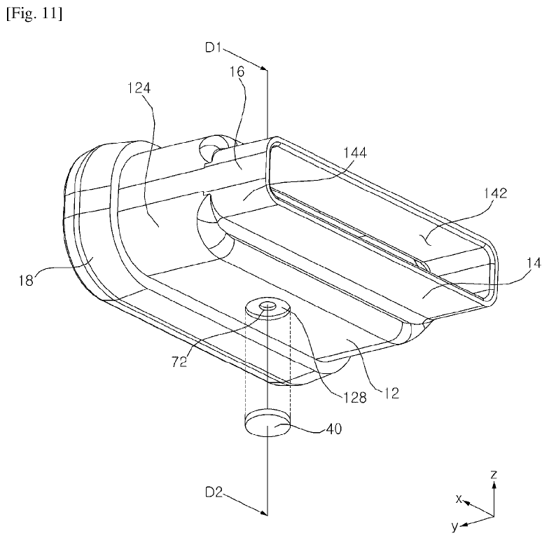

Referring to FIG. 11, in this embodiment, the membrane 40 may be in contact with the outer wall of the housing 10. The inner wall of the housing 10 may face the cavity 121 of the housing 10. The outer wall of the housing 10 may be opposite to the inner wall of the housing 10.

The housing 10 may include a recess 128. The membrane 40 may be disposed in the recess 128. The recess 128 may correspond to a position of the first vent hole 72. The recess 128 may be formed around the first vent hole 72. The recess 128 may be recessed from the outer wall of the housing 10 toward the inside of the housing 10. A size of the recess 128 may correspond to a size of the membrane 40. An edge of the recess 128 may be spaced apart from a center of the first vent hole 72. The edge of the recess 128 may extend along a circumference of the first vent hole 72. For example, the first vent hole 72 may be a circular hole formed through the housing 10, and the recess 128 may correspond to the position of the first vent hole 72 and may be a circle larger in size than the first vent hole 72.

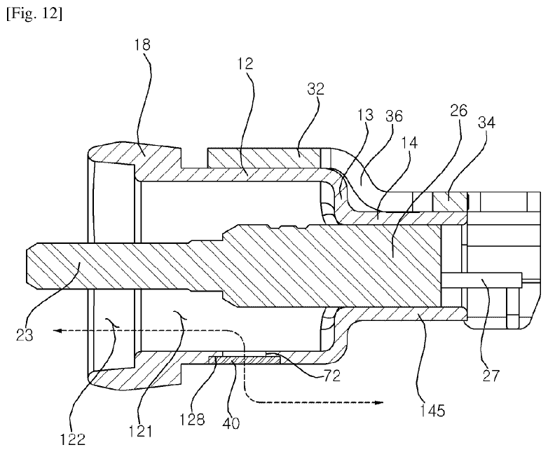

FIG. 12 is a cross-sectional view taken along line D1-D2 of FIG. 11.

Referring to FIG. 12, the membrane 40 may be disposed in the recess 128. The membrane 40 may not protrude to the outside of the housing 10. The membrane 40 may define the outer wall of the housing 10. The membrane 40 may face the first vent hole 72. The membrane 40 may cover the first vent hole 72.

Gas may pass through the first vent hole 72. The membrane 40 may be gas permeable. For example, gas inside the housing 10 may pass through the first vent hole 72 and then pass through the membrane 40 to flow out of the housing 10. For example, gas outside the housing 10 may pass through the membrane 40 and then pass through the first vent hole 72 to flow in the housing 10. For example, gas outside the device may pass through the first vent hole 72 and then pass through the membrane 40 to flow in the device. For example, gas inside the device may pass through the membrane 40 and then pass through the first vent hole 72 to flow out of the device.

The membrane 40 may be liquid impermeable in at least one direction. For example, liquid outside the device may pass through the first vent hole 72, but may not pass through the membrane 40. For example, liquid inside the device may pass through the membrane 40 and then pass through the first vent hole 72 to flow out of the device.

Accordingly, liquid inside the device may be discharged to the outside. Also, liquid outside the device may be blocked from entering the inside of the device. In addition, the waterproof performance of the receptacle connector may be improved. Further, an air pressure difference between the inside and outside of the device may be reduced.

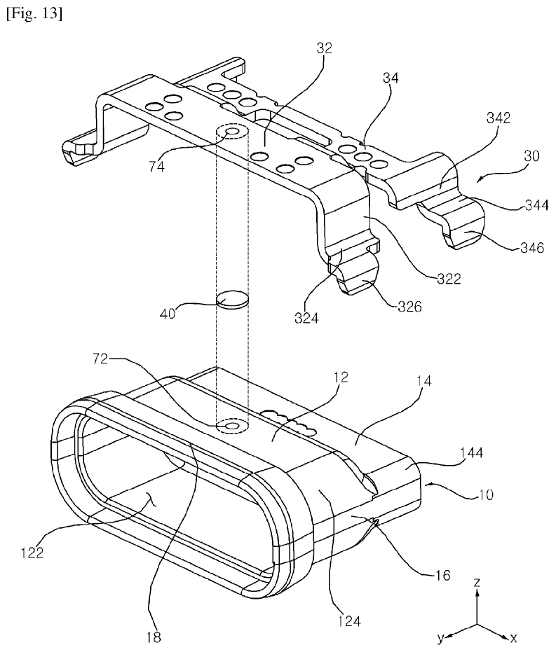

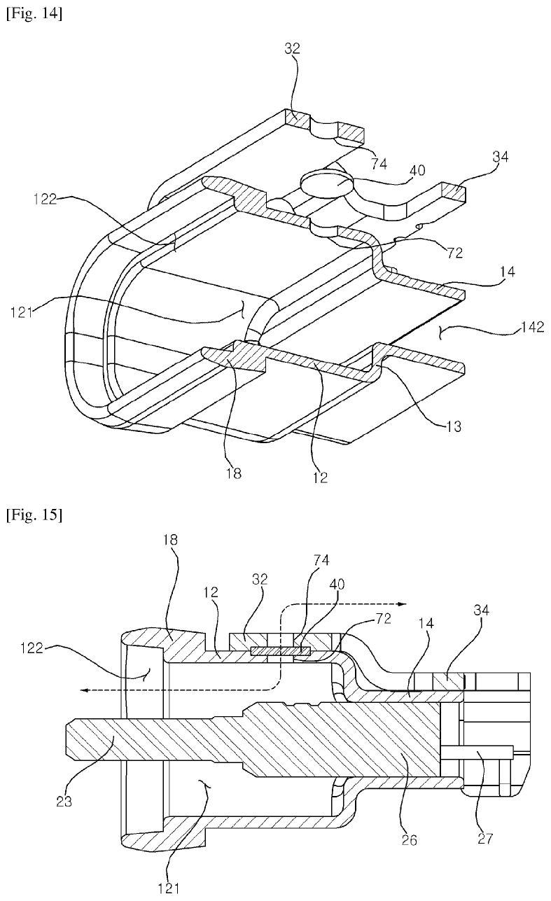

Referring to FIGS. 13 and 14, in this embodiment, the membrane 40 may be disposed between the housing 10 and the shell 30. The first vent hole 72 may be disposed on one side of the membrane 40. The second vent hole 74 may be disposed on another side of the membrane 40.

The first vent hole 72 may be formed in the housing 10. The first vent hole 72 may be formed through the housing 10. For example, the first vent hole 72 may be formed through the first housing 12.

The second vent hole 74 may be formed in the shell 30. The second vent hole 74 may be formed through the shell 30. For example, the second vent hole 74 may be formed through the first shell 32.

The first vent hole 72 and the second vent hole 74 may be arranged aligned with each other. For example, the first vent hole 72 and the second vent hole 74 may be arranged aligned with each other in the z direction.

The membrane 40 may be disposed between the first vent hole 72 and the second vent hole 74. The membrane 40 may face the first vent hole 72 and the second vent hole 74.

A size of the first vent hole 72 may be less than a size of the membrane 40. A size of the second vent hole 74 may be less than the size of the membrane 40. For example, the first vent hole 72 and the second vent hole 74 may each be a circular hole smaller in size than the membrane 40. For example, the membrane 40 may be a circular thin film larger in size than the first vent hole 72 and the second vent hole 74.

Referring to FIG. 15, gas may pass through the first and second vent holes 72 and 74. The membrane 40 may be gas permeable. For example, gas inside the housing 10 may pass through the first vent hole 72, pass through the membrane 40, and then flow out of the housing 10 through the second vent hole 74. For example, gas outside the housing 10 may pass through the second vent hole 74, pass through the membrane 40, and then flow in the housing 10 through the first vent hole 72. For example, gas outside the device may pass through the first vent hole 72, pass through the membrane 40, and then flow in the device through the second vent hole 74. For example, gas inside the device may pass through the second vent hole 74, pass through the membrane 40, and then flow out of the device through the first vent hole 72.

The membrane 40 may be liquid impermeable in at least one direction. For example, liquid outside the device may pass through the first vent hole 72, but may not pass through the membrane 40. For example, liquid inside the device may pass through the second vent hole 74, pass through the membrane 40, and then flow out of the device through the first vent hole 72.

Accordingly, liquid inside the device may be discharged to the outside. Also, liquid outside the device may be blocked from entering the inside of the device. In addition, the waterproof performance of the receptacle connector may be improved. Further, an air pressure difference between the inside and outside of the device may be reduced.

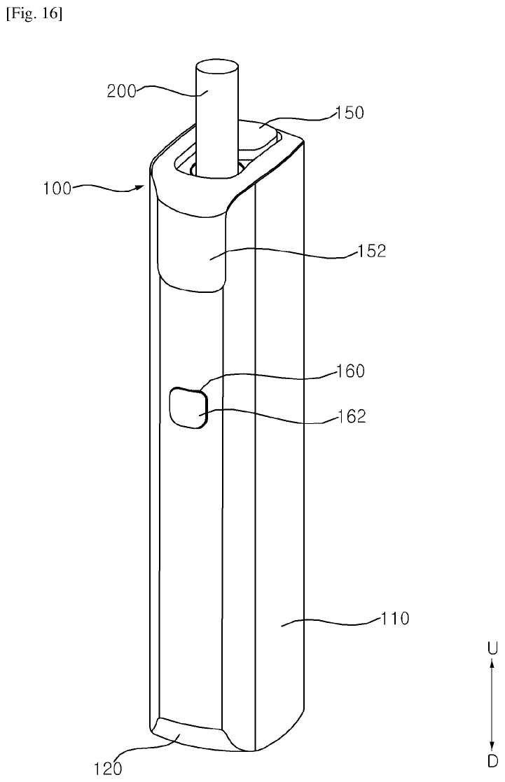

Referring to FIG. 16, a body 110 may be elongated. The body 110 may have the shape of a pipe with a cavity (or hollow) therein. For example, the body 110 may have a cuboid shape elongated in an up-and-down direction.

An insertion space (no reference numeral) may extend in a longitudinal direction of the body 110, and may be formed on a first side of the body 110. A stick 200 may be inserted into the insertion space. For example, the insertion space may extend in the up-and-down direction, and may be formed on an upper side of the body 110.

The insertion space may have a cylindrical shape. However, the shape of the insertion space is not limited thereto and may be formed in various shapes. For example, the insertion space may have a cylindrical shape with a predetermined depth.

A button key 162 may be disposed on one side or surface of the body 110. One side of the body 10 may be open to define a button hole 160. The button key 162 may be inserted into the button hole 160. When the button key 162 is pressed, the button key 162 may move toward an inside of the body 110, and may move to return to its original state.

The button key 162 may be connected to a controller (not shown). A user may transmit a command to the controller by pressing the button key 162. For example, when the button key 162 is pressed, an aerosol generating device 100 may be operated or stopped in operation.

An upper case 152 may be coupled to an upper portion of the body 110 to cover the upper portion of the body 110. The upper case 152 may be open on one side to communicate with the insertion space. The upper case 152 may include a cap 150 that opens and closes the insertion space.

The cover 120 may define a second side of the body 110. The cover 120 may have a cross-sectional shape of the body 110 so as to cover the second side of the body 110.

The cover 120 may be formed in various shapes such as a circular, rectangular, or elliptical shape. For example, the cover 120 may define a lower side of the body 110.

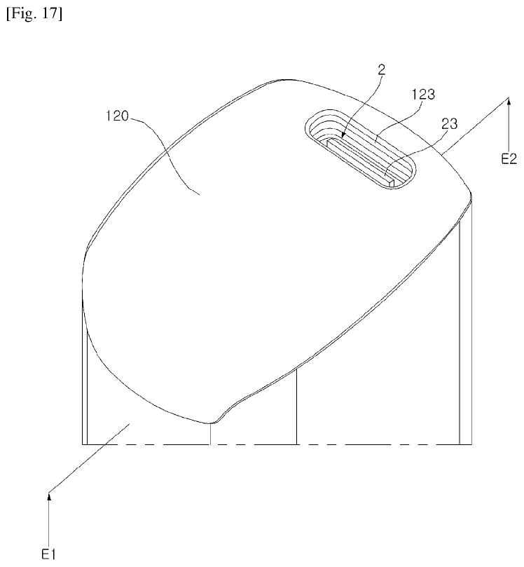

Referring to FIG. 17, a plug connector may be inserted into the second side of the body 110. A receptacle connector 2 may be installed on the second side of the body 110. For example, the receptacle connector 2 may be installed on the lower side of the body 110.

The cover 120 may include a plug slot 123 into which the plug connector is inserted. The plug slot 123 may communicate with an opening 122 of the receptacle connector 2. The opening 122 of the receptacle connector 2 may correspond to the plug slot 123. For example, a terminal 23 of the receptacle connector 2 may be exposed to the outside through the plug slot 123.

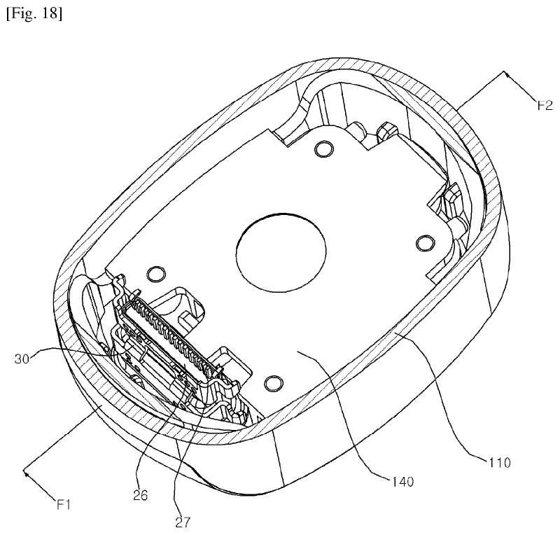

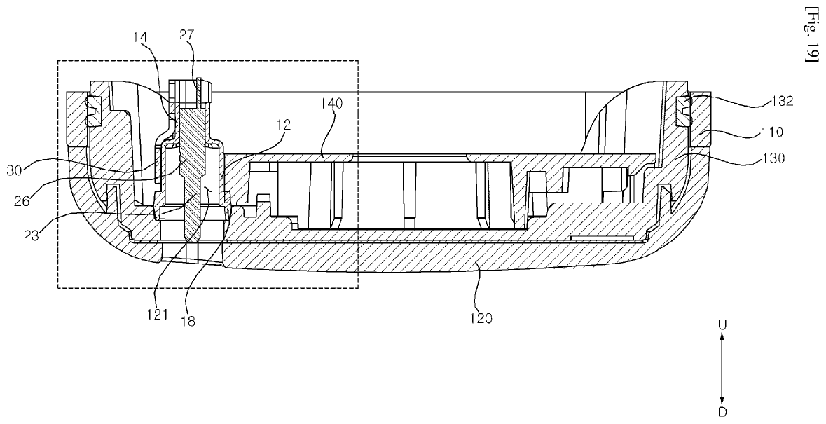

Referring to FIG. 18, the receptacle connector 2 may be installed inside the body 110. The terminal 23 may be disposed toward an outside of the body 110. A connection pin 27 may be disposed toward an inside of the body 110. The connection pin 27 may be connected to the controller disposed in the body 110. The connection pin 27 may be connected to a battery (not shown) disposed in the body 110. The plug connector may be connected to the receptacle connector 2 to allow power to be supplied to the battery.

A bracket 140 may be disposed inside the body 110. The receptacle connector 2 may be disposed adjacent to the bracket 140.

A shell 30 may face an inner wall of the body 110. The shell 30 may be coupled to the inside of the body 110. The shell 30 may be connected to the body 110, so that the receptacle connector 2 may be fixed or secured to the body 110.

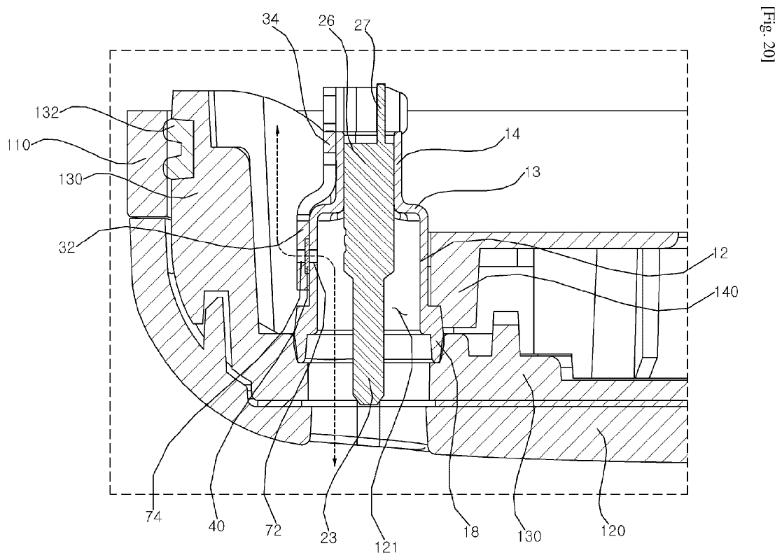

FIG. 19 is a cross-sectional view taken along line F1-F2 of FIG. 18.

Referring to FIG. 19, the bracket 140 may be disposed inside the body 110. The cover 120 may define the second side of the body 110. A base 130 may be disposed between the bracket 140 and the cover 120.

The base 130 may define the second side of the body 110. The cover 120 may cover the base 130. A portion of an edge of the base 130 may extend in the longitudinal direction of the body 110. A base sealer 132 may be disposed between the base 130 and the body 110. The base sealer 132 may fill a gap between the body 110 and the base 130.

Accordingly, the waterproof performance of the aerosol generating device may be improved.

The receptacle connector 2 may face the bracket 140. A housing 10 may face the bracket 140. The shell 30 may face an inner surface of the base 130. For example, a first housing 12 may face the bracket 140, and the shell 30 may face the inner surface of the base 130.

The terminal 23 may be disposed toward the outside of the body 110. A longitudinal direction of the terminal 23 may be parallel with the longitudinal direction of the body 110. For example, the terminal 23 and the body 110 may be elongated in the up-and-down direction.

A housing sealer 18 may come into contact with the bracket 140 and/or the base 130. The housing sealer 18 may fill a gap between the housing 10 and the bracket 140. The housing sealer 18 may fill a gap between the base 130 and the housing 10.

Thus, the waterproof performance of the aerosol generating device may be improved.

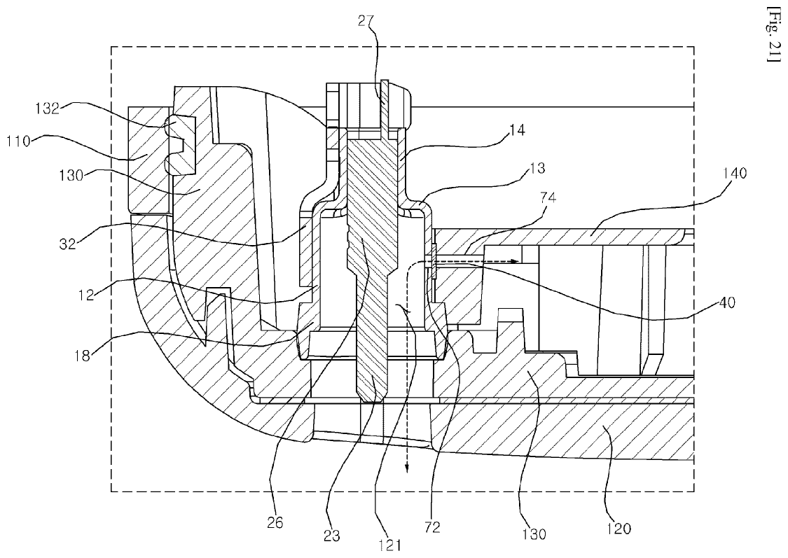

FIG. 20 is an enlarged cross-sectional view of an aerosol generating device according to an embodiment of the present disclosure.

Referring to FIG. 20, the membrane 40 may be disposed between the shell 30 and the housing 10. A first vent hole 72 and a second vent hole 74 may be arranged aligned with each other. The membrane 40 may correspond to a position of the first vent hole 72 of the housing 10. The membrane 40 may correspond to a position of the second vent hole 74 of the shell 30. The membrane 40 may be disposed between the first vent hole 72 and the second vent hole 74.

The membrane 40 may be gas permeable.

Air inside and outside the housing 10 may flow through the first vent hole 72 and the second vent hole 74. For example, gas introduced into the first vent hole 72 may pass through the membrane 40 and then be discharged into the second vent hole 74. For example, gas introduced into the second vent hole 74 may pass through the membrane 40 and then be discharged into the first vent hole 72.

Air inside and outside the aerosol generating device 100 may flow through the first vent hole 72 and the second vent hole 74. For example, gas inside the aerosol generating device 100 may be introduced into the second vent hole 74, pass through the membrane 40, and then be discharged through the first vent hole 72. For example, gas outside the aerosol generating device 100 may be introduced into the first vent hole 72, pass through the membrane 40, and then be discharged through the second vent hole 74.

Accordingly, an air pressure difference between the inside and outside of the aerosol generating device may be reduced. In addition, the durability of the aerosol generating device may be improved.

The membrane 40 may be liquid impermeable in at least one direction. For example, liquid outside the aerosol generating device 100 may pass through the first vent hole 72, but may not pass through the membrane 40. For example, liquid inside the aerosol generating device 100 may pass through the second vent hole 74, pass through the membrane 40, and then flow out of the aerosol generating device 100 through the first vent hole 72.

Thus, the waterproof performance of the aerosol generating device may be improved.

FIG. 21 is an enlarged cross-sectional view of an aerosol generating device according to another embodiment of the present disclosure.

Referring to FIG. 21, the membrane 40 may be disposed between the receptacle connector 2 and the bracket 140. A first vent hole 72 may be formed in the housing 10. For example, the first vent hole 72 may be formed on one surface of the housing 10 that faces the bracket 140.

A second vent hole 74 may be formed in the bracket 140. For example, the second vent hole 74 may be formed on one surface of the bracket 140 that faces the housing 10.

The membrane 40 may be disposed between the first vent hole 72 and the second vent hole 74. The bracket 140 may support the membrane 40. The bracket 140 may support the membrane 40 so that the membrane 40 is not separated from the housing 10.

The membrane 40 may be gas permeable.

Air inside and outside the housing 10 may flow through the first vent hole 72 and the second vent hole 74. For example, gas introduced into the first vent hole 72 may pass through the membrane 40 and then be discharged into the second vent hole 74. For example, gas introduced into the second vent hole 74 may pass through the membrane 40 and then be discharged into the first vent hole 72.

Air inside and outside the aerosol generating device 100 may flow through the first vent hole 72 and the second vent hole 74. For example, gas inside the aerosol generating device 100 may be introduced into the second vent hole 74, pass through the membrane 40, and then be discharged through the first vent hole 72. For example, gas outside the aerosol generating device 100 may be introduced into the first vent hole 72, pass through the membrane 40, and then be discharged through the second vent hole 74.

Accordingly, an air pressure difference between the inside and outside of the aerosol generating device may be reduced. Also, the durability of the aerosol generating device may be improved.

The membrane 40 may be liquid impermeable in at least one direction. For example, liquid outside the aerosol generating device 100 may pass through the first vent hole 72, but may not pass through the membrane 40. For example, liquid inside the aerosol generating device 100 may pass through the second vent hole 74 and then pass through the membrane 40 to flow out of the aerosol generating device 100.

Thus, the waterproof performance of the aerosol generating device may be improved.

Referring to FIGS. 1 to 21, a receptacle connector according to an aspect of the present disclosure includes: a housing open on one side from a cavity therein; a terminal extending to the open one side from an inside of the housing; a first vent hole formed through the housing; and a membrane to cover the first vent hole and to partition an inside and an outside of the housing.

According to another aspect of the present disclosure, the membrane may be configured to be in contact with an inner wall of the housing.

According to another aspect of the present disclosure, the housing may include a recess disposed in the inner wall thereof and formed around the first vent hole, and the membrane may be disposed in the recess.

According to another aspect of the present disclosure, the receptacle connector may further include a support having a second vent hole corresponding to the first vent hole. The membrane may be configured to be in contact with the first vent hole and the second vent hole.

According to another aspect of the present disclosure, the receptacle connector may further include a gasket disposed between the membrane and the housing. The gasket may have a gasket hole corresponding to the first vent hole.

According to another aspect of the present disclosure, the housing may include a recess disposed in an outer wall thereof and formed around the first vent hole, and the membrane may be disposed in the recess.

According to another aspect of the present disclosure, the receptacle connector may further include a shell fixed to an outer wall of the housing. The shell may have a second vent hole corresponding to the first vent hole, and the membrane may be configured to be in contact with the first vent hole and the second vent hole.

Referring to FIGS. 1 to 21, an aerosol generating device according to an aspect of the present disclosure includes: a body having an insertion space; a heater disposed in the body to be adjacent to the insertion space; a battery configured to supply power to the heater; a controller configured to control power supplied to the heater; and a receptacle connector disposed on one side of the body. The receptacle connector may include: a housing open on one side from a cavity therein; a terminal extending to the open one side from an inside of the housing; a first vent hole formed through the housing; and a membrane to cover the first vent hole and to partition an inside and an outside of the housing.

According to another aspect of the present disclosure, the receptacle connector may further include a shell fixed to an outer wall of the housing, inside the body. The shell may have a second vent hole corresponding to the first vent hole, and the membrane may be configured to be in contact with the first vent hole and the second vent hole.

According to another aspect of the present disclosure, the aerosol generating device may further include a bracket fixed to an inside of the body and facing one surface of the housing that is provided with the first vent hole, and the membrane may be configured to be in contact with the first vent hole and the second vent hole.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings, and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings, and the appended claims. In addition to variations and modifications in the component parts and/or arrangements, alternative uses will also be apparent to those skilled in the art.

1. A receptacle connector comprising:
a housing comprising an opening;
a terminal disposed in the housing and extending toward the opening;
a first vent hole formed at the housing; and
a membrane covering the first vent hole to provide a partition between an inside and an outside of the housing.

2. The receptacle connector of claim 1, wherein the membrane is configured to be in contact with an inner wall of the housing.

3. The receptacle connector of claim 2, wherein the housing comprises a recess disposed at the inner wall around the first vent hole, and
wherein the membrane is disposed in the recess.

4. The receptacle connector of claim 1, further comprising a support comprising a second vent hole corresponding to the first vent hole,
wherein the membrane is interposed between the first vent hole and the second vent hole.

5. The receptacle connector of claim 1, further comprising a gasket disposed between the membrane and the housing,
wherein the gasket comprises a gasket hole corresponding to the first vent hole.

6. The receptacle connector of claim 1, wherein the housing comprises a recess disposed at an outer wall formed around the first vent hole, and
wherein the membrane is disposed in the recess.

7. The receptacle connector of claim 1, further comprising a shell coupled to an outer wall of the housing,
wherein the shell comprises a second vent hole corresponding to the first vent hole, and
wherein the membrane is configured to be interposed between the first vent hole and the second vent hole.

8. An aerosol generating device comprising:
a body comprising an insertion space;
a heater disposed in the body to be adjacent to the insertion space;
a battery configured to supply power to the heater;
a controller configured to control power supplied to the heater; and
a receptacle connector disposed at one side of the body,
wherein the receptacle connector comprises:
a housing comprising an opening;
a terminal disposed in the housing and extending toward the opening;
a first vent hole formed at the housing; and
a membrane covering the first vent hole to provide a partition between an inside and an outside of the housing.

9. The aerosol generating device of claim 8, wherein the receptacle connector further comprises a shell disposed inside the body and coupled to an outer wall of the housing,
wherein the shell comprises a second vent hole corresponding to the first vent hole, and
wherein the membrane is configured to be interposed between the first vent hole and the second vent hole.

10. The aerosol generating device of claim 8, further comprising a bracket fixed at an inside of the body to be adjacent to the housing,
wherein the bracket comprises a second vent hole corresponding to the first vent hole, and
wherein the membrane is configured to be interposed between the first vent hole and the second vent hole.
